(19) United States
(12) Patent Application Publication
(10) Pub. No.: US 2008/0190738 A1
(43) Pub. Date: Aug. 14, 2008

(54) Combination cant turner and hook stop

(76) Inventors: Rory M. Mitchell, Beaverton, OR (US); Ronald H. Pobuda, Salmon Arm (CA)

Correspondence Address: Antony C. Edwards, P.O. Box 26020, Westbank, BC, V4T 2G3, omitted

(21) Appl. No.: 12/068,936

(22) Filed: Feb. 13, 2008

Related U.S. Application Data
(60) Provisional application No. 60/900,984, filed on Feb. 13, 2007.

(51) Int. Cl. B27B 25/00; B65G 47/24; B26D 7/06

(52) U.S. Cl. 198/413; 198/373; 198/379; 83/418; 83/705

(57) ABSTRACT

A cant turner has several discrete laterally aligned cant turning stations spaced laterally across the width of a transfer. At each station the turner has two arms that rotate independently about a corresponding shaft. The arms can be selectively oriented in-line with each other or can be set to be at an angle, for example ninety degrees to each other. When in-line and horizontal, the arms allow a cant to pass over the laterally aligned stations without interruption. When one of the arms is elevated, for example, vertically, that arm acts as a hook stop and stops cants from further translation downstream. With a cant stopped against an elevated arm, when both arms rotate in unison the cant may be forwardly turned ninety degrees and allowed to progress down the transfer.

### CROSS REFERENCE TO RELATED APPLICATION

This application claims priority from U.S. Provisional Patent Application No. 60/900,984 filed Feb. 13, 2007 entitled Combination Cant Turner and Hook Stop.

### FIELD OF THE INVENTION

This invention relates to the field of cant turners for rotating a cant about the cant's longitudinal axis while the cant is translating downstream on a transfer, and in particular to a combination cant turner and hook stop.

### BACKGROUND OF THE INVENTION

There are several different designs of cant turners that have been used in the past in the sawmill industry. One of these designs as shown in FIG. 1 is a two arm lift and let down cant turner principally used in front of horizontal resaws. With a two-sided cant in the appropriate position on the jump chains, one arm of the turner lifts the cant to the vertical position while the other arm traps it and lowers the cant down in a controlled manner. The turner is limited to turning pieces one hundred eighty degrees.

Another cant turner in the prior art is referred to in the industry as an “Elephant Trunk” design. An Elephant Trunk cant turner is shown, labeled as such, in FIG. 2. A third design of cant turner is called a “Pin” turner. A pin stop Pin-style turner is illustrated in FIG. 3. Pin turners have vertical rods that are driven vertically up on the edge of a cant to hit it with sufficient force to turn cants over backwards. Their shortcoming is that as the cant turns in an arc, the pin soon loses contact with the cant as the pin's direction is vertical. The “Elephant Trunk” design overcomes this problem as the arms also travel in an arc to more closely follow the path of the turning cant. Thus contact with the cant is maintained for a longer period of time. When one of the two cylinders is extended, the tip of the turner arms act as a ducker. When the second cylinder is extended the tips on the arms engage the edge of a cant and throw it backwards, thus turning it one hundred eighty degrees. Elephant Trunk turners are hard to control. For a heavy cant the force generated by the cylinders, pins and arms may not achieve enough momentum to turn the cant. With small cants, the force may be too much and will result in lifting the cant until it is airborne and may rotate it several times.

### SUMMARY OF THE INVENTION

In summary, the windmill cant turner for use in cooperation with a transfer having a transfer surface and supported on a frame for transferring cants downstream while the cants are oriented laterally across the direction of flow the present invention may be characterized in one aspect as including:
a) laterally oriented first and second shafts positioned so as to extend laterally across and underneath the transfer surface, wherein the first and second shafts are substantially parallel and rotatably mounted on the frame,
b) first and second arrays of elongate arms mounted spaced apart on and substantially orthogonally relative to the first shaft, wherein the first array of elongate arms is fixedly mounted on the first shaft and the second array of elongate arms is freely rotatably mounted on the first shaft so as to be rotatable on the first shaft independent of rotation of the first shaft, and wherein a drive coupler is mounted to so as to cooperate in driving engagement between the second array of elongate arms and the second shaft for selective rotation of the second array of elongate arms upon driven rotation of the second shaft, whereby selective rotation of the first shaft simultaneously rotates all first elongate arms in the first array of elongate arms and selective rotation of the second shaft simultaneously rotates all second elongate arms in the second array of elongate arms, and
c) actuating means for selectively rotating the first and second shafts independently of one another so as to simultaneously selectively rotate the first and second arrays of elongate arms independently of one another on the first shaft to thereby selectively rotate distal portions of individual the first and second elongate arms of the first and second arrays respectively through an upper arc extending above the transfer surface between a horizontal position wherein the distal portions are not elevated above the transfer surface so as to not interfere with downstream translation of a cant on the transfer, and an upright position wherein the distal portions are upwardly inclined relative to the transfer surface,

and wherein the individual first and second elongate arms each have the distal portions of sufficient length to extend upwardly from the first shaft above the transfer surface during the rotation through the upper arc, and wherein the sufficient length is long enough to support and lift a cant through the rotation of at least ninety degrees by the distal portion lifting an underside surface of the cant when the cant is positioned on and by the transfer into a turning position over and immediately adjacent the first and second shafts on an upstream side thereof.

In one embodiment the first or second array are selectively rotatable so as to position the distal portions of their corresponding the individual the first and second elongate arms in the upright position wherein the distal portions act as stops to stop translation of the cant on the transfer at the turning position, and wherein simultaneously either of the first or second arrays when in the upright position is selectively rotatable so as to position corresponding distal portions of corresponding the individual the first or second elongate arms in the horizontal position under the turning position.

In that embodiment, the first and second arrays are thereafter selectively simultaneously rotatable in a downstream rotational direction to rotate the first and second arrays by ninety degrees and the cant held therebetween through the at least ninety degrees to a downstream rotated position for downstream delivery of a turned cant to the transfer. Advantageously, the first and second arrays are selectively rotatable to independently return from the downstream rotated position.

The distal portions of the arms may have arrays of teeth extending along cant engaging portions of the distal portions. Advantageously, the arms are of sufficient length so as to be at least as long as a longest cross sectional side dimension of a cant.

In a preferred embodiment, the first and second elongate arms pivot on the first shaft about a medial point substantially medially along the length of the first and second elongate arms, and wherein equal the distal portions extend from the medial point and radially outwardly therefrom. The first and second arrays of elongate arms are mounted positioned on the first shaft so as to form pairs comprised of one the first elongate arm and one the second elongate arm mounted closely adjacent to another, and wherein the pairs are spaced laterally across the length of the first shaft.

The drive coupler may be at least one continuous flexible member providing a one-to-one drive ratio between the rotation of the second shaft and the rotation of the second array of elongate arms. The at least one continuous flexible member may be an array of drive chains rotating the second array of elongate arms. Each of the first and second elongate arms may be substantially planar orthogonal to the first shaft.

The arrays of teeth may be on a side edge of the first and second elongate members so as to be exposed for frictionally engaging a cant at least when the first or second elongate arms are in the upright position. The upright position may be selectively chosen from a range of positions between substantially vertical and inclined upstream from th everticalby substantially in the range of thirty to forty-five degrees.

The method according to the present invention of turning a cant using the cant turner according to the present invention includes the steps of:
a) scanning a cant on the transfer and determining whether the cant is to be turned in order to optimize downstream processing of the cant in a downstream machine center,
b) if the cant is not to be turned then maintain in, or rotate both the first and second arrays of elongate arms into the horizontal position,
c) if the cant is to be turned ninety degrees then maintain in or rotate one of the first or second arrays of elongate arms into the upright position while maintaining in or rotating the other of the first or second arrays of elongate arms into the horizontal position so as to engage the cant in an angular pocket formed between the first and second arrays of elongate arms, whereafter rotating the first and second arrays of elongate arms to lift the cant through the upper arc thereby rotating the cant ninety degrees downstream over the first shaft.

The method may further include the step of repositioning the upright of the elongate arms following the rotation of the cant downstream through the upper arc so as to re-form the pocket for receiving a next adjacent cant translating downstream on the transfer.

The method may yet further include the step of forming the pocket so that the upright of the elongate arms is at least thirty degrees from the vertical and pitching the cant during the rotation in the downstream direction through the upper arc so as to turn the cant one hundred eighty degrees during the rotation in the downstream direction.

### BRIEF DESCRIPTION OF THE DRAWINGS

With reference to the drawings wherein similar characters of reference denote corresponding parts in each view:

FIG. 1 is, in side elevation view, a prior art two arm lift and letdown cant turner.

FIG. 2 is, in side elevation view, a prior art pin-style cant turner.

FIG. 3 is, in side elevation view, a cant transfer for transferring a laterally oriented cant downstream along a spaced array of ducker stops wherein a windmill cant turner according to the present invention and prior art elephant trunk turner are mounted spaced along the array of ducker stops.

FIG. 4 is, in plan view, the transfer and cant turners of FIG. 3.

FIG. 5 is, in partially cut away enlarged view, the windmill turner of FIG. 3.

FIG. 6 is, in partially cut away enlarged view, the windmill turner of FIG. 4.

FIG. 7 is, in side elevation view, the pair of windmill turner arms forming part of the windmill turner according to the present invention engaging an upstream cant, ready for turning.

FIG. 8 is, in side elevation view, the cant turner of FIG. 7 rotated ninety degrees so as to rotate the cant to a ninety degrees rotated downstream position.

FIG. 9 is an enlarged partially cut away plan view of the windmill cant turning arms mounted on a drive shaft extending from a motor in an enlarged view taken from FIG. 4.

FIG. 10 is the view of FIG. 9 with the windmill cant turner arms removed from the drive shaft.

FIG. 11 is the view of FIG. 10 showing the drive shaft alone.

FIG. 12a is a sectional view along line 12a-12a in FIG. 12b.

FIG. 12b is, in plan view, one of the cant turning arms of the windmill cant turning arms according to the present invention.

FIG. 13a is a sectional view along line 13a-13a in FIG. 13b.

FIG. 13b is, in plan view, a second cant turning arm of the windmill cant turning arms according to the present invention.

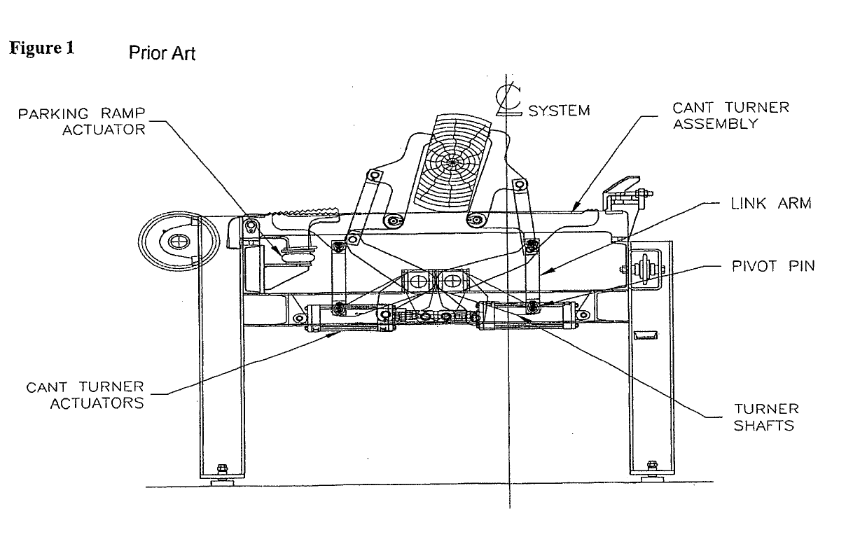

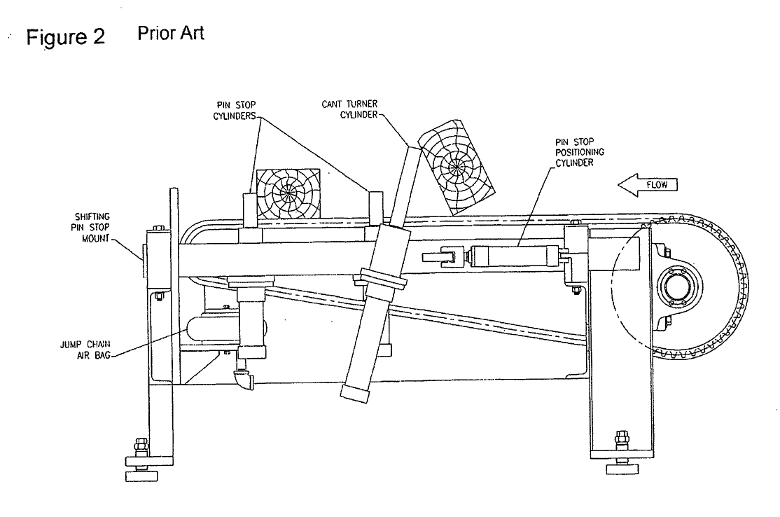

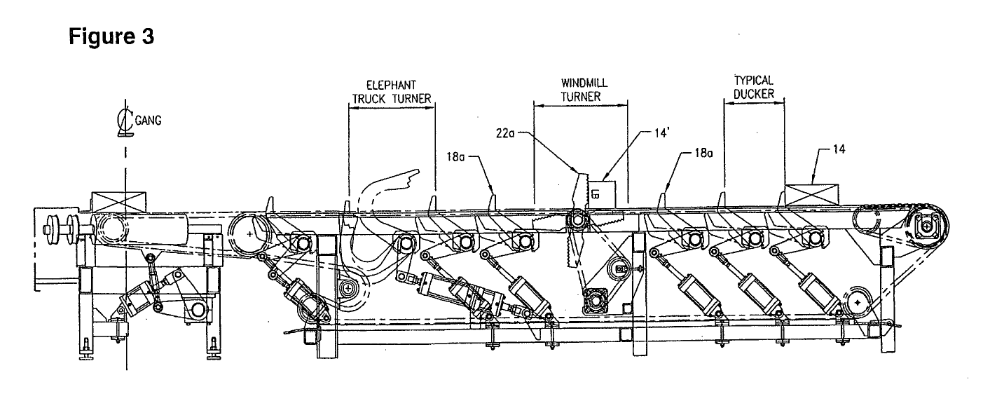

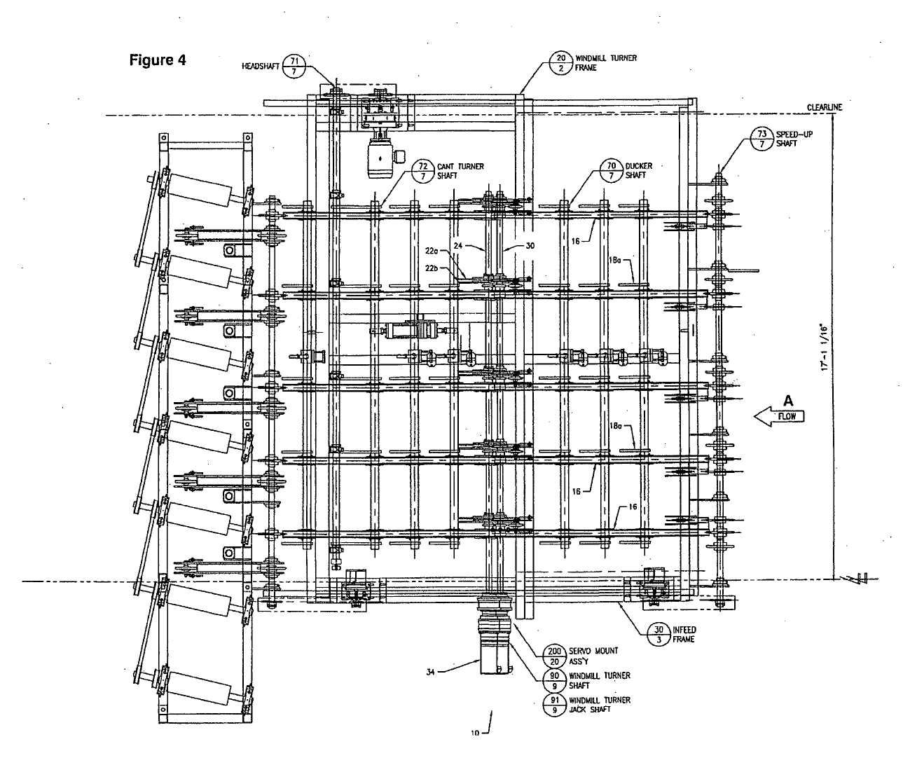

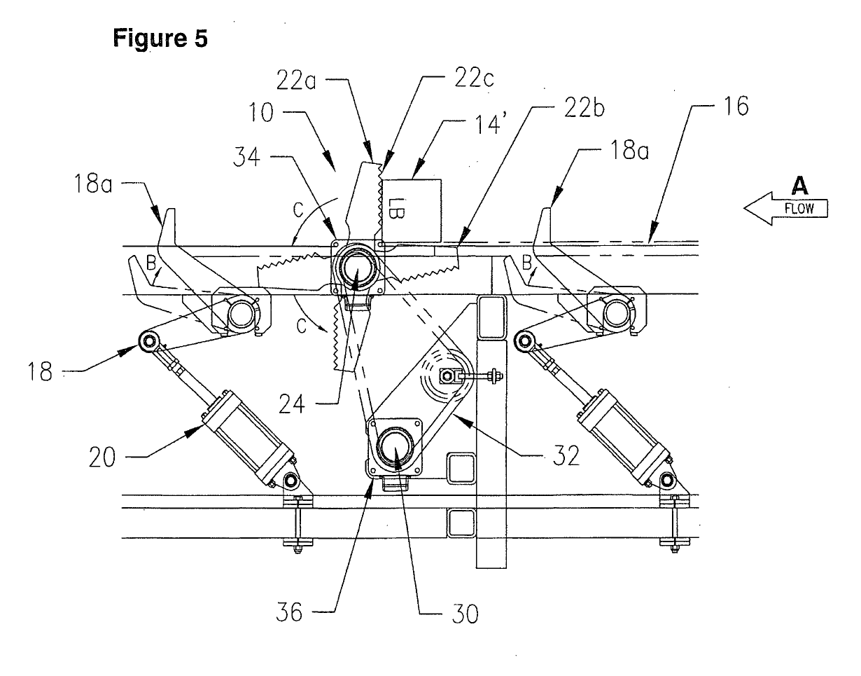

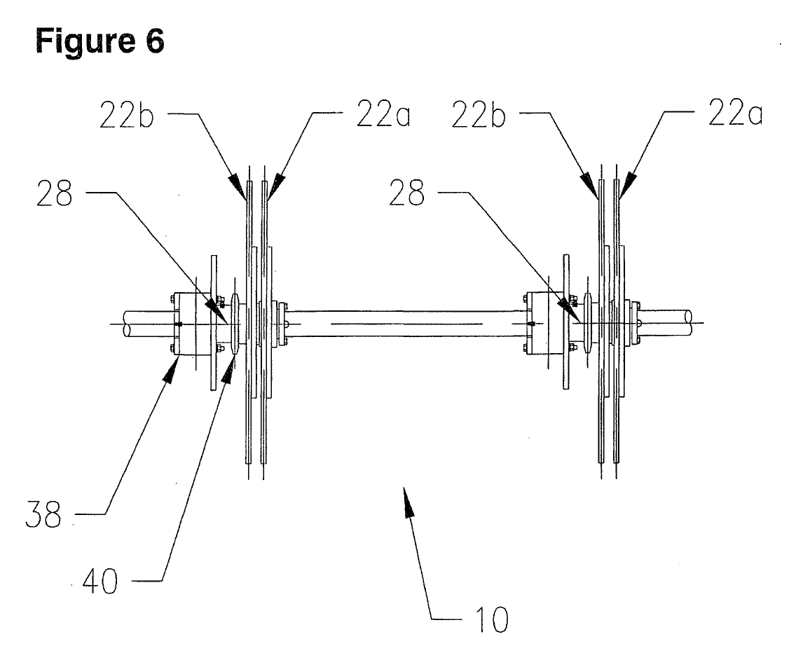

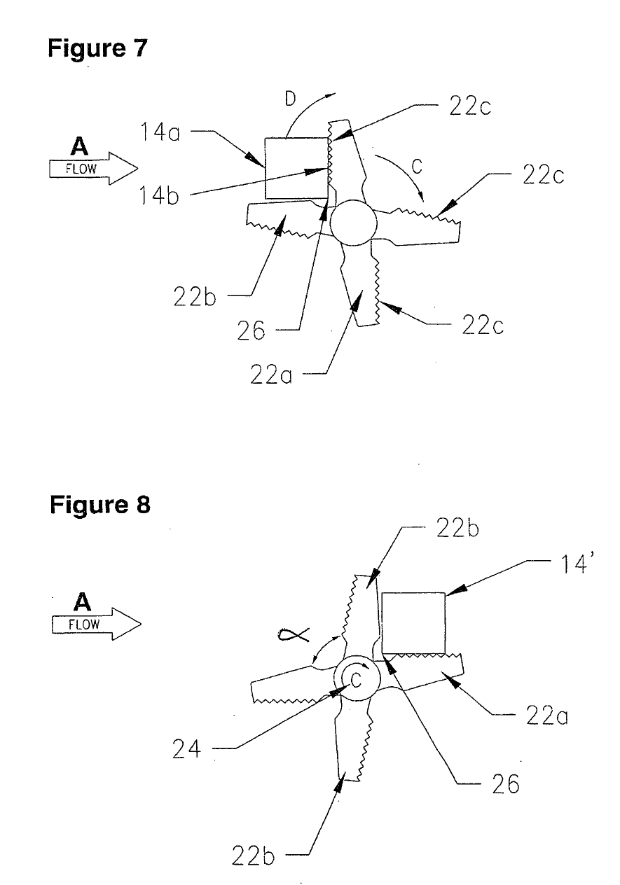

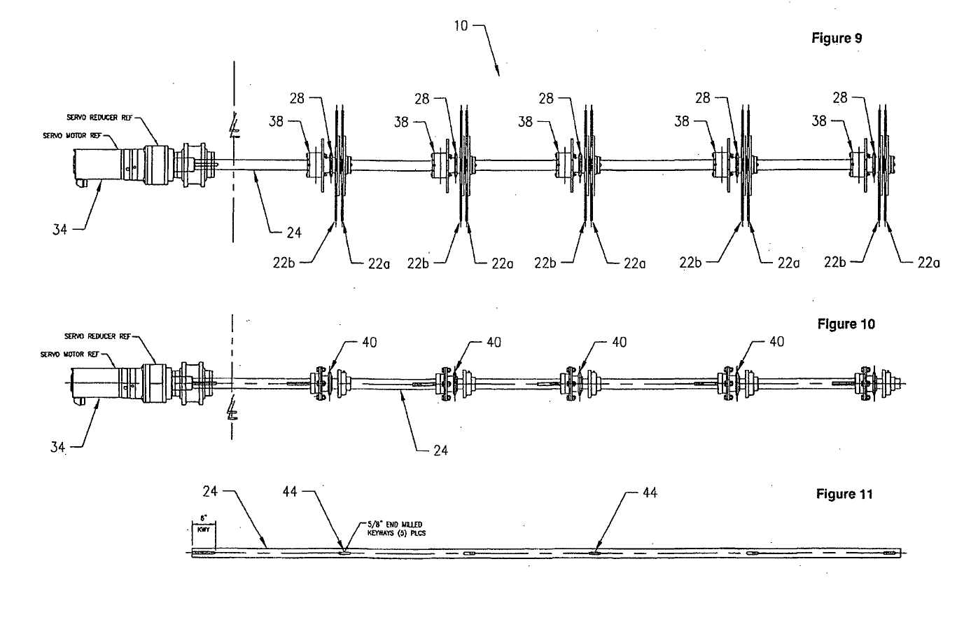

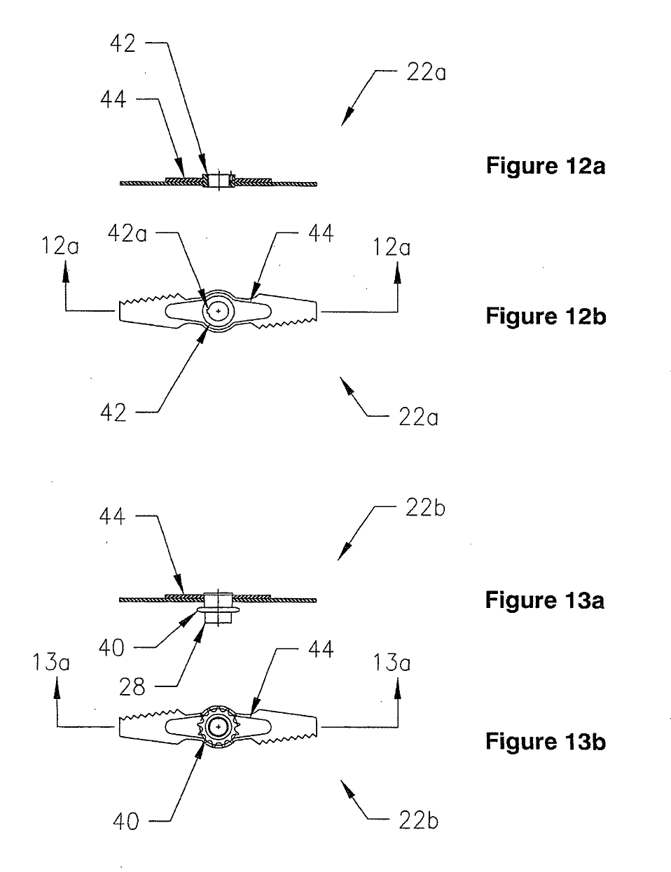

### DETAILED DESCRIPTION OF EMBODIMENTS OF THE INVENTION

This invention relates to a combination windmill turner and hook stop (hereinafter turner 10) in a queuing deck or sequencing transfer 12 where cants are translated downstream while oriented laterally across the direction of flow A in a controlled singulated manner to be fed to a downstream sawing station (not shown). Turner 10 is alternatively referred to herein as a “Windmill Turner”. The transfer is a plurality of chains 16. Hook stops 18 actuate so as to elevate distal ends 18a up in direction B above the transfer chains to stop cants 14 at discrete intervals and then to release them by dropping down below the transfer chains, allowing cants to proceed to the next hook stop when vacant. Photo-eyes (not shown) at each hook stop station determine when a hook stop is no longer retaining a cant, and allows the next upstream cant to proceed to the adjacent downstream station.

In operation, sometimes a cant has to be turned so that downstream the optimal face of the cant will end up resting against a linebar in the sawing station. The optimal face, optimal sawing solution, etc. is determined by a scanner (not shown) or other sensing device cooperating with an optimizer.

Turner 10 may have several discrete cant laterally aligned turning stations 10a spaced laterally across the width of the transfer 12. In particular, at each station 10a the turner 10 has two arms 22a and 22b that rotate independently in direction C about shaft 24. Thus the arms can be selectively oriented in-line with each other or can be set to be at an angle, for example ninety degrees to each other. When in-line and horizontal, the arms allow a cant 14 to pass over the laterally aligned stations 10a in direction A without interruption. When one or other of arms 22a or 22b are elevated, for example vertical, that arm acts as a hook stop and stops cants 14 from further translation downstream. For example then, with arm 22a vertical and arm 22b horizontal, and with a cant 14′ stopped against arm 22a, when both arms rotate in unison in direction C from this position, cant 14′ is turned ninety degrees and allowed to progress in direction A down the transfer. This arrangement is called forward turning.

Alternatively, if set in motion at the appropriate time in a direction opposite to direction C, the arms working together in unison rotate cants 14 in that opposite direction. This is called backward turning. If three turners 10 are placed in sequence down the transfer length in the direction of flow, each turner 10 may turn a cant ninety degrees thereby allowing cants to be selectively also turned one hundred eighty or two hundred seventy degrees as each cant is turned sequentially ninety degrees at two or three of the successive turners 10.

A single turner 10 can forward turn a two-sided cant one hundred eighty degrees by angling the vertical arm back in the upstream direction to create a pocket 26 of less than ninety degrees, for example forty-five to sixty degrees. With a cant stopped in pocket 26, the two arms 22a and 22b rotate forwarding unison in direction C so that the initially vertical arm rotates to the horizontal. This is done with sufficient rotational velocity to pitch the cant forward. In particular teeth 22c on the vertical arm frictionally engage the cant's downstream face 14b as the cant is pitched forward in direction D by the rotation of the arms. As the cant is simultaneously pitched forward in direction D and rotated in direction C, the cant pivots about the corner of the cant between faces 14a and 14b as that corner is caught on the teeth. The initially “top” face 14a then rolls over onto the initially vertical arm as that arm rotates to the horizontal. The cant is thereby rotated one hundred eighty degrees and lowered to the transfer. The lifting arm, that is the initially horizontal arm, lifts the cant so as to pitch it in direction D, and follows through past the vertical during the pitching of the cant. Once the cant has been so pitched, what was initially the lifting arm swings in a reverse direction back past the vertical to create the turn pocket 26 for the next cant.

One set of arms 22a are fixed to a rotatable shaft 24. The other set of arms 22b are supported on a bearing mounted idler hub 28 on the same shaft 24 but driven from a separate drive shaft 30 with drive chains 32 so that the arms can be rotated separately that is independently of one another. The drive to each shaft is with a motor, respectively motors 34 and 36, whose speed, direction of rotation, acceleration and deceleration are precisely controlled. Typically an electric servo motor is employed for each shaft.

Arm 22b is mounted onto shaft 24 sandwiched between bearing housing 38 and arm 22a. A drive sprocket 40 is mounted onto idler hub 28 so as to be driven by drive chain 32 and motor 36. Arm 22a is mounted onto a collar 42. Collar 42 has a keyway 42a which mates with keys 44 on shaft 24 so that collar 42 and arm 22a rotate simultaneously with shaft 24. Thus arm 22a is rotatable on shaft 24 independently of the rotation of arm 22b, shaft 24 being selectively rotatable by the actuation of motor 34, and arms 22b being selectively rotatable by the actuation of motor 30. Stiffeners 44 are mounted to the arms and their corresponding hubs.

The upstream scanner or sensor looks at the cant shape and other characteristics and determines the optimum face to be presented to the cutting tools. This information is relayed to the turner control which configures the arms to pass, stop or turn the cant.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps maybe present, or utilized, or combined with other elements, components, or steps that are not expressly referenced.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A windmill cant turner for use in cooperation with a transfer having a transfer surface and supported on a frame for transferring cants downstream while the cants are oriented laterally across the direction of flow, the cant turner comprising:
laterally oriented first and second shafts positioned so as to extend laterally across and underneath said transfer surface, wherein said first and second shafts are substantially parallel and rotatably mounted on said frame,
first and second arrays of elongate arms mounted spaced apart on and substantially orthogonally relative to said first shaft, wherein said first array of elongate arms is fixedly mounted on said first shaft and said second array of elongate arms is freely rotatably mounted on said first shaft so as to be rotatable on said first shaft independent of rotation of said first shaft, and wherein a drive coupler is mounted to so as to cooperate in driving engagement between said second array of elongate arms and said second shaft for selective rotation of said second array of elongate arms upon driven rotation of said second shaft, whereby selective rotation of said first shaft simultaneously rotates all first elongate arms in said first array of elongate arms and selective rotation of said second shaft simultaneously rotates all second elongate arms in said second array of elongate arms,
actuating means for selectively rotating said first and second shafts independently of one another so as to simultaneously selectively rotate said first and second arrays of elongate arms independently of one another on said first shaft to thereby selectively rotate distal portions of individual said first and second elongate arms of said first and second arrays respectively through an upper arc extending above said transfer surface between a horizontal position wherein said distal portions are not elevated above said transfer surface so as to not interfere with downstream translation of a cant on the transfer, and an upright position wherein said distal portions are upwardly inclined relative to said transfer surface,
and wherein said individual said first and second elongate arms each have said distal portions of sufficient length to extend upwardly from said first shaft above said transfer surface during said rotation through said upper arc, and wherein said sufficient length is long enough to support and lift a cant through said rotation of at least ninety degrees by said distal portion lifting an underside surface of the cant when the cant is positioned on and by the transfer into a turning position over and immediately adjacent said first and second shafts on an upstream side thereof.

2. The cant turner of claim 1 wherein said first or second array are selectively rotatable so as to position said distal portions of their corresponding said individual said first and second elongate arms in said upright position wherein said distal portions act as stops to stop translation of the cant on the transfer at said turning position, and wherein simultaneously either of said first or second arrays when in said upright position is selectively rotatable so as to position corresponding distal portions of corresponding said individual said first or second elongate arms in said horizontal position under said turning position,
and wherein said first and second arrays are thereafter selectively simultaneously rotatable in a downstream rotational direction to rotate said first and second arrays by ninety degrees and the cant held therebetween through said at least ninety degrees to a downstream rotated position for downstream delivery of a turned cant to the transfer,
and wherein said first and second arrays are selectively rotatable to independently return from said downstream rotated position.

3. The cant turner of claim 2 wherein said distal portions have arrays of teeth extending along cant engaging portions of said distal portions.

4. The cant turner of claim 2 wherein said sufficient length is at least as long as a longest cross sectional side dimension of a cant.

5. The cant turner of claim 2 wherein said first and second elongate arms pivot on said first shaft about a medial point substantially medially along the length of said first and second elongate arms, and wherein equal said distal portions extend from said medial point and radially outwardly therefrom.

6. The cant turner of claim 5 wherein said first and second arrays of elongate arms are mounted positioned on said first shaft so as to form pairs comprised of one said first elongate arm and one said second elongate arm mounted closely adjacent to another, and wherein said pairs are spaced laterally across the length of said first shaft.

7. The cant turner of claim 5 wherein said drive coupler is at least one continuous flexible member providing a one-to-one drive ratio between said rotation of said second shaft and said rotation of said second array of elongate arms.

8. The cant turner of claim 7 wherein said at least one continuous flexible member is an array of drive chains rotating said second array of elongate arms.

9. The cant turner of claim 5 wherein each said first and second elongate arms are substantially planar orthogonal to said first shaft.

10. The cant turner of claim 3 wherein said arrays of teeth are on a side edge of said first and second elongate members so as to be exposed for frictionally engaging a cant at least when said first or second elongate arms are in said upright position.

11. The cant turner of claim 1 wherein said upright position is selectively chosen from a range of positions between substantially vertical and inclined upstream from the vertical by substantially forty-five degrees.

12. The cant turner of claim 11 wherein said range of positions is between said substantially vertical and inclined upstream from the vertical by substantially thirty degrees.

13. A method of using a windmill cant turner in cooperation with a transfer having a transfer surface and supported on a frame for transferring cants downstream while the cants are oriented laterally across the direction of flow, wherein the cant turner includes:
laterally oriented first and second shafts positioned so as to extend laterally across and underneath said transfer surface, wherein said first and second shafts are substantially parallel and rotatably mounted on said frame,
first and second arrays of elongate arms mounted spaced apart on and substantially orthogonally relative to said first shaft, wherein said first array of elongate arms is fixedly mounted on said first shaft and said second array of elongate arms is freely rotatably mounted on said first shaft so as to be rotatable on said first shaft independent of rotation of said first shaft, and wherein a drive coupler is mounted to so as to cooperate in driving engagement between said second array of elongate arms and said second shaft for selective rotation of said second array of elongate arms upon driven rotation of said second shaft, whereby selective rotation of said first shaft simultaneously rotates all first elongate arms in said first array of elongate arms and selective rotation of said second shaft simultaneously rotates all second elongate arms in said second array of elongate arms,
actuating means for selectively rotating said first and second shafts independently of one another so as to simultaneously selectively rotate said first and second arrays of elongate arms independently of one another on said first shaft to thereby selectively rotate distal portions of individual said first and second elongate arms of said first and second arrays respectively through an upper arc extending above said transfer surface between a horizontal position wherein said distal portions are not elevated above said transfer surface so as to not interfere with downstream translation of a cant on the transfer, and an upright position wherein said distal portions are upwardly inclined relative to said transfer surface,
and wherein said individual said first and second elongate arms each have said distal portions of sufficient length to extend upwardly from said first shaft above said transfer surface during said rotation through said upper arc, and wherein said sufficient length is long enough to support and lift a cant through said rotation of at least ninety degrees by said distal portion lifting an underside surface of the cant when the cant is positioned on and by the transfer into a turning position over and immediately adjacent said first and second shafts on an upstream side thereof,
wherein said first or second array are selectively rotatable so as to position said distal portions of their corresponding said individual said first and second elongate arms in said upright position wherein said distal portions act as stops to stop translation of the cant on the transfer at said turning position, and wherein simultaneously either of said first or second arrays when in said upright position is selectively rotatable so as to position corresponding distal portions of corresponding said individual said first or second elongate arms in said horizontal position under said turning position,
and wherein said first and second arrays are thereafter selectively simultaneously rotatable in a downstream rotational direction to rotate said first and second arrays by ninety degrees and the cant held therebetween through said at least ninety degrees to a downstream rotated position for downstream delivery of a turned cant to the transfer,
and wherein said first and second arrays are selectively rotatable to independently return from said downstream rotated position,
the method comprising the steps of:
a) scanning a cant on the transfer and determining whether the cant is to be turned in order to optimize downstream processing of the cant in a downstream machine center,
b) if the cant is not to be turned then maintain in, or rotate both said first and second arrays of elongate arms into said horizontal position,
c) if the cant is to be turned ninety degrees then maintain in or rotate one of said first or second arrays of elongate arms into said upright position while maintaining in or rotating the other of said first or second arrays of elongate arms into said horizontal position so as to engage the cant in an angular pocket formed between said first and second arrays of elongate arms, whereafter rotating said first and second arrays of elongate arms to lift the cant through said upper arc thereby rotating the cant ninety degrees downstream over said first shaft.

14. The method of claim 13 further comprising the step of re-positioning the upright of said elongate arms following said rotation of the cant downstream through said upper arc so as to re-form said pocket for receiving a next adjacent cant translating downstream on said transfer.

15. The method of claim 14 further comprising the step of forming said pocket so that said upright of said elongate arms is at least thirty degrees from the vertical and pitching the cant during said rotation in said downstream direction through said upper arc so as to turn the cant one hundred eighty degrees during said rotation in said downstream direction.
